(19) United States
(12) Patent Application Publication
(10) Pub. No.: US 2026/0208255 A1
(43) Pub. Date: Jul. 23, 2026

(54) EXPANDING BLADE FOR USE IN MANUFACTURING MICRO-EXPANDED METAL MESH FOILS AND METHODS OF FABRICATING THE SAME

(71) Applicant: ACS Industries, Inc., Lincoln, RI (US)

(72) Inventor: George Greenwood, Tiverton, RI (US)

(73) Assignee: ACS Industries, Inc., Lincoln, RI (US)

(21) Appl. No.: 19/452,242

(22) Filed: Jan. 17, 2026

Related U.S. Application Data
(60) Provisional application No. 63/746,926, filed on Jan. 18, 2025.

(51) Int. Cl. B21D 31/04; B21D 37/20

(52) U.S. Cl. CPC B21D 31/043; B21D 37/205

(57) ABSTRACT

The present disclosure relates to the manufacture of expanded metal mesh, and more particularly to a novel expanding blade which may be used for micro-expanding very thin metal mesh foil sheets (12.5µm to 50µm thickness) with a mesh pore size of about 5µm to about 50µm and a porosity (mesh open area) of 10-50%. The expanding blade may have a blade tooth pitch of 15µm to 75µm (400 – 1440 teeth per inch). The disclosure further relates to laser ablation and wire EDM methods of fabricating an expanding blade with the identified tooth pitch and characteristics.

### CROSS-REFERENCE TO RELATED APPLICATIONS

This application is a non-provisional filing of, and claims the benefit of, U.S. Provisional Patent Application No. 63746926, filed January 18, 2025, the entire contents of which is incorporated herein by reference.

### BACKGROUND OF THE DISCLOSURE

(1) Field of the Invention: The instant invention relates to the manufacture of expanded metal, and more particularly to a novel expanding blade which is used for micro-expanding very thin metal foil sheets, and to methods of fabricating the expanding blade.

(2) Description of Related Art: Metal expanding is a metal forming process initially developed in 1884 in which a blade with defined tooth pitch reciprocates up and down and left and right, to slit a metal sheet and create predictable, repeatable well-defined openings as the metal sheet advances through the expander (see FIG. 1).

Expanded metal has diverse applications as structural components, energy absorbing materials, filters, electrodes for battery applications, etc. Properties include high strength and rigidity, mass efficiency, and high porosity. Expanded metal is highly economical due to its production directly from sheet metal with near zero waste material. However, standard expanding technology is currently limited to applications with pore sizes and distributions down to about a 1 mm pitch.

### SUMMARY OF THE DISCLOSURE

The instant invention relates to the manufacture of expanded metal mesh, and more particularly to a novel expanding blade which may be used for micro-expanding very thin metal mesh foil sheets (12.5µm to 50µm thickness) with a mesh pore size of about 5µm to about 50µm, and a porosity (mesh open area) of 10-50%. The expanding blade may have a blade tooth pitch or density of about 15µm to about 75µm (400 to 1400 teeth per inch). The blade characteristics represent at least a 10x reduction in blade tooth size, depth and pitch relative to existing technologies.

An exemplary expanding blade in accordance with the teachings herein may comprise a rectangular blade body having appropriate length, width and depth required to perforate or expand a desired width and thickness of metal foil. The exact dimensions of the blade body are not critical and may be dimensioned as needed for specific applications.

The exemplary blade may be made from a standard grade of Tungsten Carbide material with a fine grain size (1-2µm average) and Cobalt binder, such as GC-206, GC-209 or GC-211 available from General Carbide^{tm} corporation. The Tungsten Carbide and Cobalt binder weight percentages may vary amongst the different grade materials. (General Carbide specification sheets are attached as an addendum). Other grades of Tungsten Carbide may also be utilized as may be appropriate for tooth size, strength or other parameters.

As noted above, the tooth characteristics specified herein represent at least a 10x reduction in size from existing technologies and are achieved using novel fabrication methods.

Exemplary tooth densities capable within the current disclosure range from about 400 teeth per inch up to about 1440 teeth per inch.

The exemplary blades may be used with metal foils ranging in thickness from 12.5µm (smaller tooth pitch) to about 50µm (larger tooth pitch).

The disclosure also relates to methods of fabricating the blade to achieve the exponentially smaller tooth characteristics.

A first exemplary method of fabrication is laser ablation utilizing a green wavelength femtosecond fiber laser. The fiber laser format allows for the adjustment of peak power and/or pulse repetition rate without affecting any of the output beam parameters. The beam quality, ultrashort pulse duration and high pulse energy combine to provide peak power densities suitable for micromachining virtually any material including metal and Tungsten Carbides. The ultrashort pulse duration and green wavelength result in negligible heat affected zone. Such laser(s) can be paired with focal lenses to provide a focal point as small as 1µm to systematically ablate the carbide material to create the required tooth profiles. In order to reduce localize heat buildup within the carbide material, the laser ablation system may be programmed to jump predetermined distances to adjacent or remote spots to allow localized cooling, and then later return to remove additional material.

Another exemplary method of fabrication is wire Electrical Discharge Machining (EDM) which is effective for fabricating small and complex geometries. Wire is a metal fabrication process that uses electrical sparks to cut or shape various materials. A wire electrode is fed through a dielectric liquid and charged to a high voltage. The wire then arcs across the gap to the workpiece, melting a small amount of material. The deionized water cools and flushes away the melted material.

Ablation and/or wire EDM of the carbide material may create jagged or rough tooth surfaces, particularly on the side surfaces within the troughs. To smooth these surfaces, a diamond paste slurry using nanometer (nm) diamond grains is pumped across and through the teeth to smooth out the ablated or wire EDM trough surfaces.

### BREIF DESCRIPTION OF THE DRAWING FIGURES

While the specification concludes with claims particularly pointing out and distinctly claiming particular embodiments of the instant invention, various embodiments of the invention can be more readily understood and appreciated from the following descriptions of various embodiments of the invention when read in conjunction with the accompanying drawings in which:

FIG. 1 is a perspective illustration of an exemplary metal mesh expanding apparatus;

FIG. 2 is a perspective illustration of an exemplary expanding blade configured and fabricated in accordance with the teachings of the present invention;

FIG. 3 is an enlarged perspective illustration thereof depicting the tooth orientation and density;

FIG. 4 is a plan view illustration depicting tooth pitch; and

FIGS. 5-7 are further enlarged illustrations showing dimensional characteristics of the tooth pitch, trough depth and tooth end surface.

### DETAILED DESCRIPTION OF THE PREFERRED AND EXEMPLARY EMBODIMENTS

Certain exemplary embodiments will now be described to provide an overall understanding of the principles of the structure, function, manufacture, and use of the device and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present disclosure. Further, in the present disclosure, like-numbered components of the embodiments generally have similar features, and thus within a particular embodiment each feature of each like-numbered component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape. Further, to the extent that directional terms like top, bottom, up, or down are used, they are not intended to limit the systems, devices, and methods disclosed herein. A person skilled in the art will recognize that these terms are merely relative to the system and device being discussed and are not universal.

Unless otherwise specified, when referring to a numerical value, the term “about” is intended to be construed as including a range of values within +/-10% of the value being referred to.

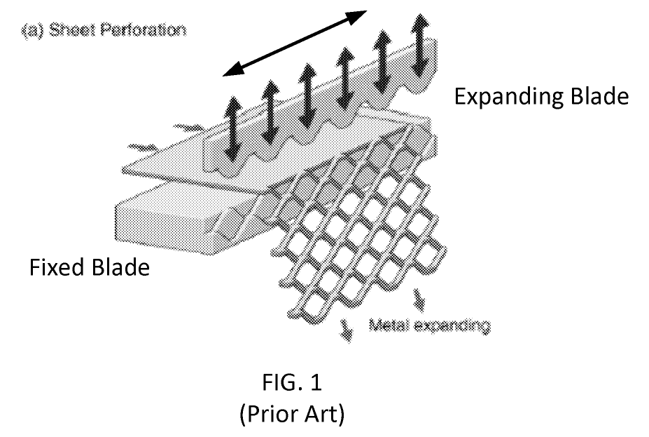

The instant invention generally relates to the manufacture of expanded metal (See FIG. 1) utilizing an expanding apparatus including a fixed blade and an expanding blade, wherein the expanding blade reciprocates up and down and left and right, to slit a metal sheet and create predictable, repeatable well-defined openings 18 as the metal sheet advances through the expanding apparatus.

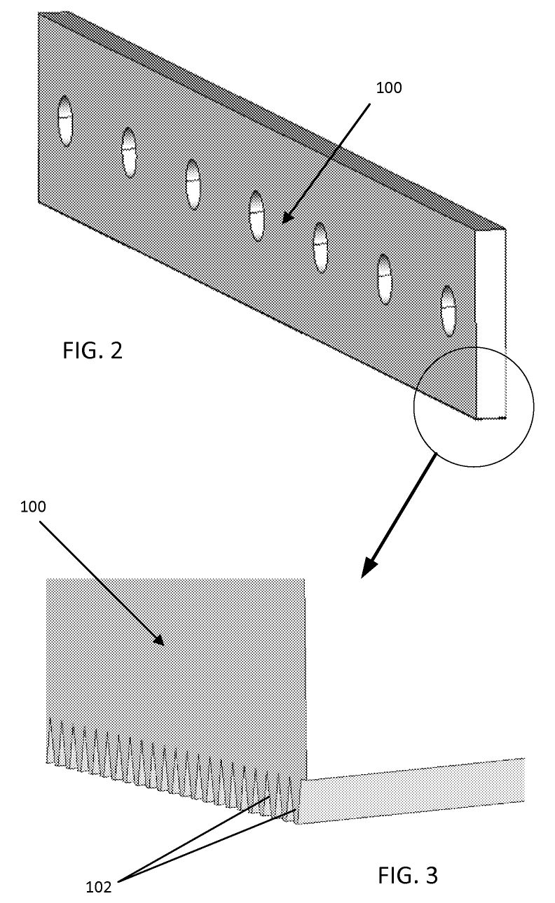

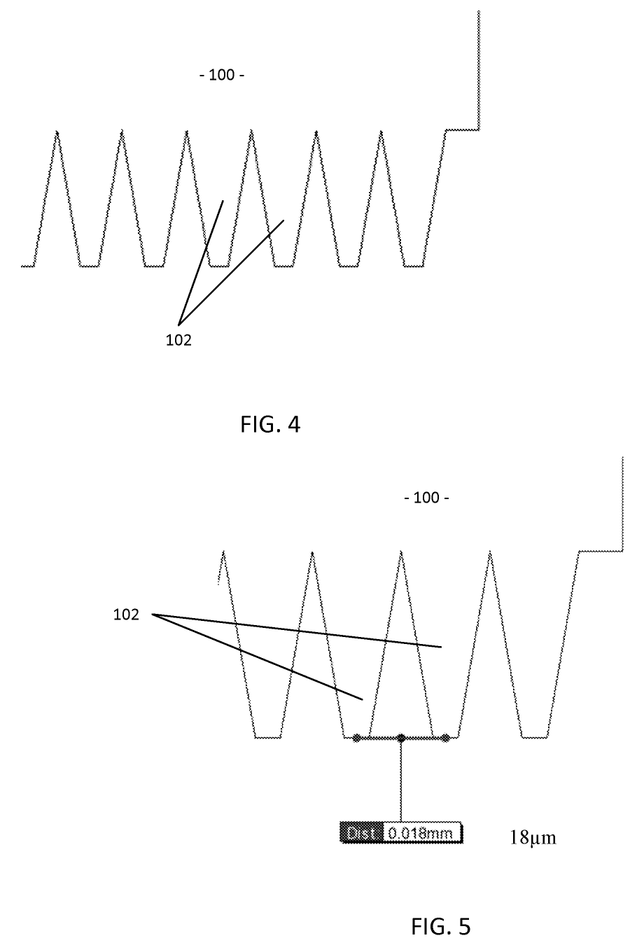

More particularly referring to FIGS. 2-7, the invention relates to a novel expanding apparatus utilizing an expanding blade 100 which may be used for micro-expanding very thin metal mesh foil sheets (12.5µm to 50µm thickness) with a mesh pore size of about 5µm to about 50µm and a porosity (mesh open area) of 10-50%.

The expanding blade 100 may include a plurality of cutting teeth 102 having a blade tooth pitch or spacing of 15µm to 75µm (400 – 1400 teeth per inch). The expanding blade characteristics represent at least a 10x reduction in blade tooth size, depth and pitch relative to existing technologies.

An exemplary expanding blade 100 in accordance with the teachings herein may comprise a rectangular blade body having appropriate length, width and depth required to perforate or expand a desired width and thickness of metal foil.

Referring to FIG. 2, an exemplary blade 100 is illustrated having an approximate length of 152.4mm (6in), width of 19.0mm (.75in) and depth of 3.18mm (.125in). The exact dimensions of the blade body are not critical and may be dimensioned as needed for specific applications.

The exemplary blade 100 may be made from a standard grade of Tungsten Carbide material with a fine grain size (1-2µm average) and Cobalt binder, such as GC-206, GC-209 or GC-211 available from General Carbide^{tm} corporation. The Tungsten Carbide and Cobalt binder weight percentages may vary amongst the different grade materials. Other grades of Tungsten Carbide may also be utilized as may be appropriate for tooth size, strength or other parameters.

As noted above, the specified tooth characteristics herein represent at least a 10x reduction in size from existing technologies, and are achieved using novel fabrication methods.

Exemplary tooth densities capable within the current disclosure range from 400 teeth per inch up to 1440 teeth per inch.

Exemplary tooth characteristics may fall in the following ranges:

Tooth Density about 400 to about 1440 teeth per inch (TPI);

Tooth Pitch about 15µm to about 75µm;

Tooth Depth (trough depth) about 34µm to about 140µm;

Tooth End Width about 4µm to about 19µm.

Referring to FIGS. 2-7, the exemplary blade 100 depicted in the illustrations is an actual fabricated model having 1400 teeth per inch with the following dimensional characteristics.

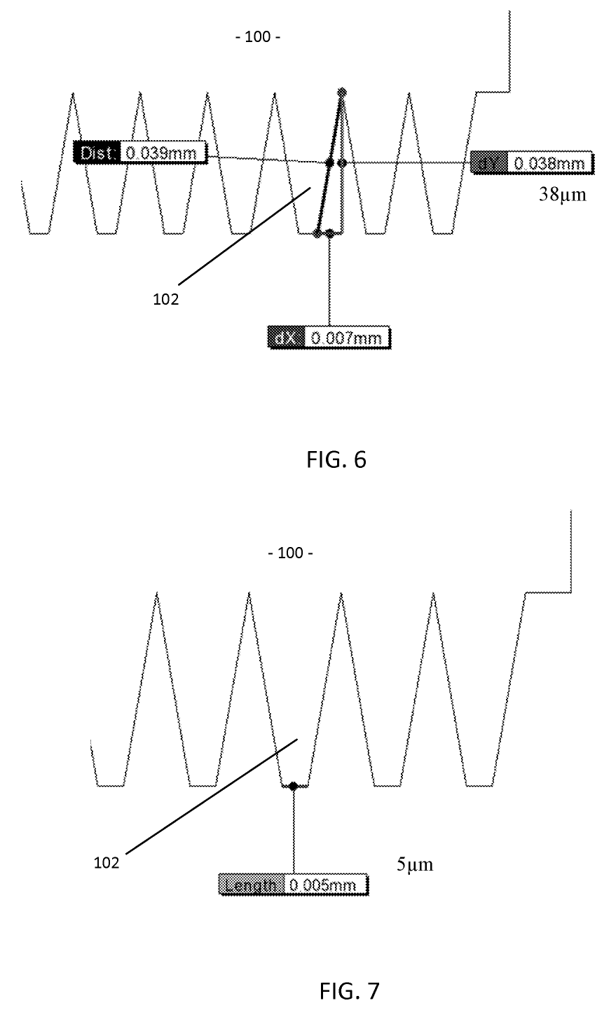

Referring to FIG. 5, a 1400 tooth per inch pitch equals a tooth spacing of about 18µm. FIG. 6 illustrates a tooth depth of about 38µm, while FIG. 7 illustrates a flattened tooth end of about 5µm. Reciprocating travel of an expanding blade is limited to about 2/3 of the depth of the teeth 102 to prevent breakage, wherein the exemplary teeth 102 may provide a range of pore sizes from about 5-6µm up to about 12-13µm (representing about 2/3 of the blade pitch).

Scaling the tooth sizes up (larger) to about 400 teeth per inch would result in a pitch of about 63µm and a tooth depth of about 133µm with a flat end of about 12-17.6µm and providing a range of pore sizes from about 12-13µm to about 48-50µm.

The exemplary blades may be used with metal foils ranging in thickness from 12.5µm (smaller tooth pitch) to about 50µm (larger tooth pitch).

An exemplary metal foil may comprise titanium.

### BLADE FABRICATION

The disclosure also relates to methods of fabricating the blade 100 to achieve the exponentially smaller tooth characteristics.

A first exemplary method of fabrication comprises laser ablation utilizing a green wavelength (for example a 515nm wavelength) femtosecond fiber laser. Exemplary lasers are available from IPG Photonics^{tm}, such as the GLPF-10-500-20-R Fiber Laser. Green femtosecond fiber lasers may provide pulses with 10 μJ pulse energy with scalable average output power of 20 W and customer selected pulse durations in the range of 250-500 fs at full operational repetition rate range of 50-2000 kHz. The fiber format allows for the adjustment of peak power and/or pulse repetition rate without affecting any of the output beam parameters. The beam quality, ultrashort pulse duration and high pulse energy combine to provide peak power densities suitable for micromachining virtually any material including metal and Tungsten Carbides as utilized herein for the blade 100. The ultrashort pulse duration and green wavelength result in negligible heat affected zone.

Such fiber laser(s) can be paired with focal lenses to provide a focal point as small as 1µm to systematically ablate the carbide material to create the required tooth profiles.

Carbide materials are particularly sensitive to overheating which can reduce strength. In order to reduce localized heat buildup within the carbide material, the laser ablation fabrication system may be programmed to jump predetermined distances to adjacent or remote spots to allow localized cooling, and then later return to previous locations remove additional material.

Another exemplary method of fabrication is wire Electrical Discharge Machining (EDM) which is effective for fabricating small and complex geometries. Wire EDM is a metal fabrication process that uses electrical sparks to cut or shape various materials. A wire electrode is fed through a dielectric liquid (deionized water) and charged to a high voltage. The wire then arcs across the gap to the workpiece, melting a small amount of material. The deionized water cools and flushes away the melted material.

In the present disclosure, wire EDM fabrication will be limited by the available diameter of EDM wires, which may range from 0.0005in (12.7µm) to 0.013in (330µm), as well as tooth pitch and geometry. In referencing the illustrated 1400 TPI blade, the smallest wire EDM may not be quite suitable for this smallest tooth size. However, wire EDM may be utilized for a larger 400 to 800 TPI blades which are within the contemplated blade designs.

Ablation and/or wire EDM of the carbide material may create jagged or rough tooth surfaces, particularly on the side surfaces within the troughs. To smooth these surfaces, a diamond paste slurry using nanometer (nm) diamond grains is pumped across and through the teeth so smooth out the ablated surfaces.

While there is shown and described herein certain specific structures embodying various embodiments of the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed is:

1. An expanding blade for use in micro-expanding a metal foil sheet having a thickness of 12.5µm to 50µm thickness, the expanding blade comprising:
a generally rectangular tungsten carbide body having a length, width and depth,
said body including a plurality of expanding teeth with a tooth pitch of about 15µm to about 75µm, a trough depth between teeth of about 34µm to about 130µm, and a tooth end width of about 4µm to about 19µm,
wherein said expanding blade is capable of producing a metal expanded mesh foil with a mesh pore size of about 5µm to about 50µm, and a porosity (mesh open area) of about 10-50%.

2. The expanding blade of claim 1 wherein said body including a plurality of expanding teeth with a tooth pitch of about 18µm, a trough depth between teeth of about 38µm, and a tooth end width of about 5µm,
wherein said expanding blade is capable of producing a metal expanded mesh foil with a mesh pore size of about 5µm to about 13µm.

3. The expanding blade of claim 1 wherein the tungsten carbide body has a fine grain size of about 1-2µm and Cobalt binder.

4. The expanding blade of claim 2 wherein the tungsten carbide body has a fine grain size of about 1-2µm and Cobalt binder.

5. A method of fabricating an expanding blade for use in micro-expanding a metal foil sheet having a thickness of 12.5µm to 50µm thickness, the method comprising the steps of:
providing a generally rectangular tungsten carbide body having a length, width and depth; and
ablating material from the tungsten carbide body using a green wavelength femtosecond fiber laser to produce a plurality of expanding teeth with a tooth pitch of about 15µm to about 75µm, a trough depth between teeth of about 34µm to about 130µm, and a tooth end width of about 4µm to about 19µm.

6. The method of claim 5 further comprising the step of focusing a fiber laser beam from the fiber laser with a lens capable of producing a laser spot size of about 1µm.

7. The method of claim 5 where the fiber laser may provide pulses with 10 μJ pulse energy, an average output power of about 20 W, and selective pulse durations in the range of 250-500 fs at an operational repetition rate range of 50-2000 kHz.

8. The method of claim 5 further comprising the step of polishing the fabricated tooth surfaces by pumping a diamond slurry paste across the fabricated tooth surfaces.

9. The method of claim 5 further comprising the step of selectively and systematically moving the fiber laser focal spot from a first spot to an adjacent sport or a remote spot to allow localized cooling of the carbide body.

10. The method of claim 6 further comprising the step of polishing the fabricated tooth surfaces by pumping a diamond slurry paste across the fabricated tooth surfaces.

11. The method of claim 6 further comprising the step of selectively and systematically moving the fiber laser focal spot from a first spot to an adjacent sport or a remote spot to allow localized cooling of the carbide body.

12. The method of claim 10 further comprising the step of selectively and systematically moving the fiber laser focal spot from a first spot to an adjacent sport or a remote spot to allow localized cooling of the carbide body.

13. A method of fabricating an expanding blade for use in micro-expanding a metal foil sheet having a thickness of 12.5µm to 50µm thickness, the method comprising the steps of:
providing a generally rectangular tungsten carbide body having a length, width and depth; and
removing material from the tungsten carbide body using an Electrical Discharge Machining (EDM) wire to produce a plurality of expanding teeth with a tooth pitch of about 37µm to about 75µm.

14. The method of claim 13 further comprising the step of polishing the fabricated tooth surfaces by pumping a diamond slurry paste across the fabricated tooth surfaces.
